(19) United States
(12) Patent Application Publication
(10) Pub. No.: US 2018/0185837 A1
(43) Pub. Date: Jul. 5, 2018

(54) APPARATUS FOR ANALYZING A LIQUID SAMPLE INCLUDING A LOCKING AND WITHDRAWAL DEVICE

(71) Applicant: AVALUN, Grenoble (FR)

(72) Inventors: Patrick Pouteau, Meylan (FR); Vincent Poher, Guines (FR); Paul Laurens, Gillonnay (FR)

(21) Appl. No.: 15/740,967

(22) PCT Filed: Jul. 1, 2016
(86) PCT No.: PCT/FR2016/051683

§ 371 Date: Dec. 29, 2017

(30) Foreign Application Priority Data
Jul. 3, 2015 (FR) 1556309

(51) Int. Cl. B01L 3/00

(52) U.S. Cl. CPC B01L 3/508; B01L 2300/0654; B01L 2200/04; B01L 2200/025

(57) ABSTRACT

A liquid-sample analyzer includes a housing that delimits an interior space and a recess adapted to receive a main body of a collection device that collects a liquid sample. When inserted into the recess, the main body extends longitudinally from the opening along a longitudinal axis of the collection device. The detection-and-analysis device is configured to detect and to analyze at least one representative parameter of the liquid sample. The locking-and-releasing retains the collection device in a locking position when the main body has been inserted into the recess. The releasing member exerts an ejection force on the main body toward the opening. The abutment portion contacts a bearing portion of the main body so as to immobilize the collection device while the main body is subjected to the ejection force.

### RELATED APPLICATIONS

This is the national stage of PCT/FR2016/051683, filed on Jul. 1, 2016 which claims the benefit of the Jul. 3, 2015 priority date of French application FR1556309 the contents of which are herein incorporated by reference.

### FIELD OF INVENTION

The invention relates to liquid-sample analysis, and in particular, to detection of analytes in a biological liquid.

### BACKGROUND

It is known to detect analytes in various liquids. This is typically carried out by collecting a liquid in a collection device and inserting that collection device, together with the liquid to be analyzed, into an analysis apparatus. Within the apparatus, some type of sensor is present to measure some property of the liquid. An example of a sensor is an optical sensor.

Suitable liquids for analysis include liquids of biological origin, such as blood.

### SUMMARY

The invention relates to an analysis apparatus adapted to cooperate with a device for collecting a liquid sample and including a device for locking and releasing the collection device. The invention also relates to a method of analyzing the liquid sample collected.

In one aspect, the invention features an analysis device for analyzing a liquid sample. The analysis device is adapted to cooperate with a collection device for collecting said liquid sample. Such a device includes a housing and a device for detection and analysis of at least one representative parameter of the liquid sample. The housing delimits an interior space and has an opening that leads into a recess. The recess is adapted to receive a main body of the collection device disposed in the interior space. It extends longitudinally from the opening along a longitudinal axis of the collection device.

In some embodiments, the analysis device includes a locking-and-releasing device that is adapted to retain the collection device in a locking position when the main body is inserted into the recess. The locking-and-releasing device includes a releasing member and a locking member. The releasing member is adapted to exert an ejection force on the main body of the collection device in a direction substantially parallel to the longitudinal axis of the recess and is oriented toward the opening of the recess. The locking member includes at least one abutment portion adapted to be in contact with a bearing portion of the main body of the collection device so as to immobilize the collection device then subjected to the ejection force along the longitudinal axis of the recess.

The collection device is preferably removable. As such, it can be removed, disengaged, or even ejected from the analysis apparatus, and in particular, from the housing of the analysis apparatus.

In some embodiments, the analysis device includes a bearing surface that is fixed relative to the recess and disposed so as to, at least in part, delimit the recess. The bearing surface extends in a direction parallel to an insertion axis of the recess so as to be able to contact a portion of the main body containing a fluidic measurement chamber of the collection device when the latter is inserted into the recess.

In other embodiments, the locking member is mobile relative to the recess in a manner substantially transverse to the longitudinal axis thereof and adapted to exert a bearing force on the main body in the direction of the bearing surface when the latter body is inserted into the recess.

In yet other embodiments, the locking member includes a contact surface oriented toward the recess and having a proximal spacing part relative to the opening of the recess. The locking member is inclined relative to the longitudinal axis of the recess. The abutment portion lies between the proximal spacing part and a distal bearing part.

In some embodiments, the locking-and-releasing device includes an unlocking member, actuation of which causes the locking member to escape abutment between the abutment portion thereof and the bearing portion of the collection device. This ejects the main body relative to the recess because of the effect of the ejection force.

In some embodiments, the analysis device includes at least one spacing element disposed longitudinally along an edge of the bearing surface and projecting relative thereto in the direction of the recess. Beveled longitudinal ends of the spacing element move the main body away from the bearing surface when it moves in the recess along the longitudinal axis.

In some embodiments, the detection-and-analysis device includes an optical sensor located on the side of the bearing surface that is opposite to the recess. In these embodiments, the bearing surface is transparent to light beams emanating from the measuring chamber when the main body of the collection device is inserted into the recess.

The detection-and-analysis device includes an optical sensor that is separated from the recess' opening by a longitudinal distance. In some embodiments, this longitudinal distance is less than or equal to two centimeters. In other embodiments, a transverse distance separates the sensor from the recess' opening. This transverse distance is less than or equal to two centimeters.

Other embodiments include a heating device that has a heating element adapted to transmit heat to the main body via the bearing surface while the main body contacts the bearing surface.

In yet other embodiments, the detection-and-analysis device includes a light source and an optical sensor disposed on opposite sides of the recess along an illumination axis of the collection device's main body while the main body is inserted into the recess. The locking member includes a hollow part positioned between the light source and the optical sensor to enable propagation of the illumination beams along the illumination axis through the hollow part.

In some embodiments, the housing includes an upper wall and a lower wall connected to each other by a lateral wall having a width between the walls that is less than the dimensions of the upper and lower walls. The opening of the housing is located at the level of the upper wall of the housing and the recess extending in a substantially orthogonal manner to the latter wall in the direction of the lower wall.

In some embodiments, the upper wall of the housing comprises a display screen.

In another aspect, the invention features a system for analyzing a liquid sample. Such a system includes an analysis apparatus having any of the above features, together with a device for collecting the liquid sample. The collection sample includes a main body and a receiving surface. The main body extends along a longitudinal axis and includes a measurement chamber. The main body is adapted to be inserted longitudinally in the housing along the longitudinal insertion axis thereof.

A receiving surface is adapted to be located outside the recess to receive the liquid sample when the main body is inserted into the recess, is assembled to the main body, and comprises a collection orifice in fluid communication with the measurement chamber. In some embodiments, the receiving surface extends in a substantially orthogonal manner to the longitudinal axis of the main body.

In some embodiments, the recess is sized so that, when the main body of the collection device is inserted into the recess, the distance between the collection orifice and the measurement chamber is approximately equal to the distance between the opening of the recess and the measurement chamber. Among these embodiments are those in which it is less than or equal to two centimeters.

In some embodiments, the collection device includes a collection part assembled to the main body, one surface of which forms the receiving surface. The collection part contacts a wall of the housing at the edge of the recess' opening when the main body of the collection device is inserted into the recess.

In some embodiments, the collection device has a main body having a shoulder that forms the bearing portion. The shoulder lies between a central first part and a distal end of the main body facing the measurement chamber. The central first part contains a measurement chamber.

An apparatus as described herein is suitable for analyzing a liquid sample. The liquid sample can be obtained from a biological liquid, such as blood, saliva, urine, interstitial liquid, or any other type of liquid. Analysis includes detecting or analyzing a representative parameter thereof.

Analyzing the liquid sample amounts to evaluating one or more representative parameters of the liquid sample.

These parameters can be or derived from optical properties. Examples of optical properties include visual indicators of absorption rates, colorimetry, and interference patterns.

Parameters can also be derived form electrical properties. Examples include impedance and conductance.

Parameters can also be derived from chemical properties of the liquid sample. Examples include presence and concentration of analytes.

Examples of analysis include detecting and evaluating the presence and the concentration of one or more analytes present in the liquid sample. Examples of analytes include biological particles such as cells, bacteria, proteins or one of their constituents. The liquid sample can include one or more reagents liable to modify proportionately or not one or more of the properties of the liquid sample to be analyzed.

### BRIEF DESCRIPTION OF THE DRAWINGS

These and other features of the invention will be apparent from the following detailed description and the accompanying figures, in which:

FIG. 1a is a perspective view of an analysis system comprising an apparatus for analyzing a liquid sample and a device for collecting the liquid sample inserted therein;

FIG. 1b is a diagrammatic sectional view of a part of the analysis system shown in FIG. 1a with the collection device inserted into the analysis apparatus;

FIG. 2a is a front view of an example of the collection device shown in FIG. 1a;

FIG. 2b is a perspective view showing the male and female parts forming the collection device shown in FIG. 2a;

FIGS. 3a to 3c are diagrammatic views down the Y, X, and Z axes respectively of the locking and disengagement device;

FIG. 4a shows the locking-and-releasing device when the collection device is being inserted;

FIG. 4b shows the locking-and-releasing device in its locking position;

FIGS. 5a and 5b are perspective views of an example of the locking and releasing device; and

FIG. 6 shows an optical sensor including a heating device.

In the figures and in the remainder of the description the same references represent identical or similar elements. Also, in an effort to enhance the clarity of the figures, the various elements are not shown to scale.

### DETAILED DESCRIPTION OF PARTICULAR EMBODIMENTS

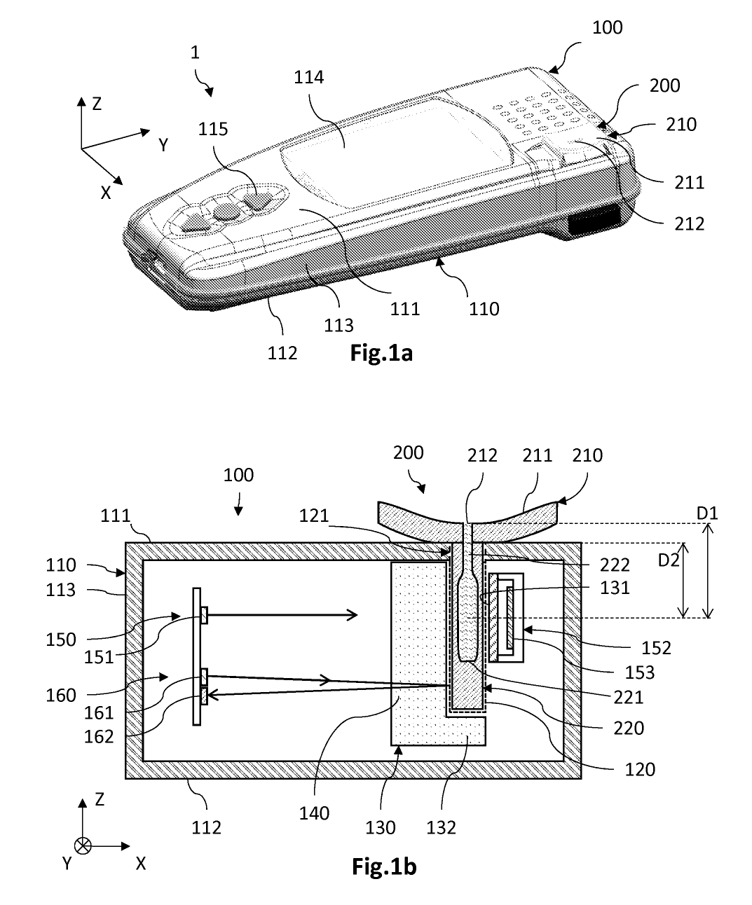

FIG. 1a shows an analysis system 1 having a liquid-sample analyzer 100. A collection device 200 is inserted into the liquid-sample analyzer. The collection device 200 collects the liquid sample that is to be analyzed.

Throughout the remainder of the description, reference will be made to a three-dimensional frame-of-reference in which an X-axis extends in the direction of the analysis apparatus' width, a Y-axis extends in the direction of its length, and the Z-axis extends in the direction of its thickness.

The liquid-sample analyzer 100 includes an upper wall 111, a lower wall 112, and a lateral wall 113 that together define a housing 110 that delimits the interior space. The lateral wall 113 extends all around the contour of the apparatus and connects the upper wall 111 and the lower wall 112 to each other.

In the figure, the upper wall 111 and the lower wall 112 are substantially coplanar with the XY plane. The upper wall 111 includes a display screen 114 and keys 115 for selecting various modes of using the apparatus. In the example shown in the figure, the liquid-sample analyzer 100 has a thickness that is less than its width and its length.

FIG. 1b shows a section in the XZ plane of a part of the liquid-sample analyzer 100 shown in FIG. 1a with the collection device 200 inserted therein.

Within the housing's interior space a recess 120, a locking-and-releasing device 130, and a detection-and-analysis device 150.

The recess 120 receives a part of the collection device 200 that contains the liquid sample. The recess 120 is adapted to receive a part of the collection device 200 in a position that will enable detection and analysis of the liquid sample. An opening 121 at the level of the housing's upper wall 111 provides communication between the recess 120 and the environment. The recess 120 extends along a longitudinal insertion axis from the opening 121 towards the lower wall 112.

The locking-and-releasing device 130 locks and releases the collection device 200. The locking-and-releasing device 130 delimits part of the recess 120. It includes a bearing surface 131, a locking member 140, and a releasing member 132.

The detection-and-analysis device 150 detects and analyzes one or more characteristic properties of the liquid sample.

The bearing surface 131 extends longitudinally along one side of the recess 120. The locking member 140 is disposed on the side of the recess 120 opposite the bearing surface 131. The releasing member 132 is located facing the lower part of the recess 120, i.e., the distal part of the recess 120 relative to the opening 121.

The collection device 200 is inserted into a recess 120 of the liquid-sample analyzer 100. The recess 120 is level with the upper wall 111 so that only a collection part 210 of the collection device 200 can be seen outside the apparatus.

The collection part 210 has an upper surface 211 for receiving a liquid sample. In the example shown, the receiving surface 211 is substantially orthogonal to the longitudinal axis of that part of the collection device 200 that is inserted into the recess 120 and to that of the recess 120. However, in some embodiments, the receiving surface 211 is substantially parallel to the same longitudinal axis, notably when the opening is located at the level of the housing's lateral wall 113. The receiving surface 211 includes a collection orifice 212 to enable the introduction of the liquid sample into the collection device 200 and therefore into the liquid-sample analyzer 100 to permit the liquid-sample analyzer 100 to proceed with analyzing the sample.

In operation, the collection part 210 remains outside the recess 120. The rest of the collection device 200 is inserted into the recess 120.

As used herein, “a receiving surface 211 substantially orthogonal, respectively parallel, to the longitudinal axis of the recess 120, or insertion axis” means that, when the collection device 200 is inserted into the liquid-sample analyzer 100, the receiving surface 211 has a plane tangential to the surface at the level of the collection orifice 212, substantially orthogonal, respectively parallel, to the insertion axis.

In the particular example shown herein, the collection device 200 includes a collection part 210 and a main body 220. The collection part 210 has, at an upper part thereof, a receiving surface 211 that receives the liquid sample. The main body 220 extends longitudinally and substantially orthogonally to the collection part 210.

In some embodiments, the collection device 200 has a receiving surface 211 that extends parallel to the main body 220. However, in the embodiment shown herein, the main body's longitudinal axis is substantially orthogonal to a plane tangential to the receiving surface 211 at the level of the collection orifice 212.

The main body 220 includes a measurement chamber 221 that is in fluid communication with the collection orifice 212 via the duct 222. In the figure, the collection device 200 is inserted into the recess 120 so that the main body 220 engages the recess 120 and the collection part 210 remains outside the recess 120.

Having the collection part 210 rest on or contact the housing's wall permits accurate positioning of he collection device 200 in the liquid-sample analyzer 100 along the insertion axis and also provides support for the collection part 210 while depositing the liquid sample, thereby offering more even distribution of mechanical stresses.

The detection-and-analysis device 150 detects and analyzes one or more characteristic properties of the sample. Depending on the nature of the detection-and-analysis device 150, these properties can be electrical, chemical and/or optical properties.

In the illustrated example, the detection-and-analysis device 150 is configured to detect optical properties. As such, it includes one or more light sources 151 and an optical sensor 152. In the illustrated embodiment, the light source 151 is disposed to illuminate the measurement chamber 221 that has been inserted into the recess 120. It does so along an illumination direction that is parallel to the X-axis.

The optical sensor 152 includes a photodetector 153 disposed behind the bearing surface 131 in the illumination direction. The bearing surface 131 is made from a material that is transparent to the incident beams coming from the illuminated measurement chamber 221. As described in detail later, it is advantageous for the detection-and-analysis device 150 to perform optical detection using a lensless imaging technique. The locking member 140 disposed between the light source 151 and the optical sensor 152 has a structure to enable the passage of the illumination beams in the direction of the recess 120 without disturbing the beams.

The detection-and-analysis device 150 further includes an analysis unit that processes the measured data. The analysis unit connects to the display screen 114 to display information to the user. The analysis unit includes a processor and a memory able to store software for processing the measured data. This analysis unit can also store data, communicate with elements external to the liquid-sample analyzer 100, such as a computer system, manage the button interfaces, and supply electrical power to the detection-and-analysis device 150. An electrical power supply battery can be provided inside the housing 110 of the liquid-sample analyzer 100.

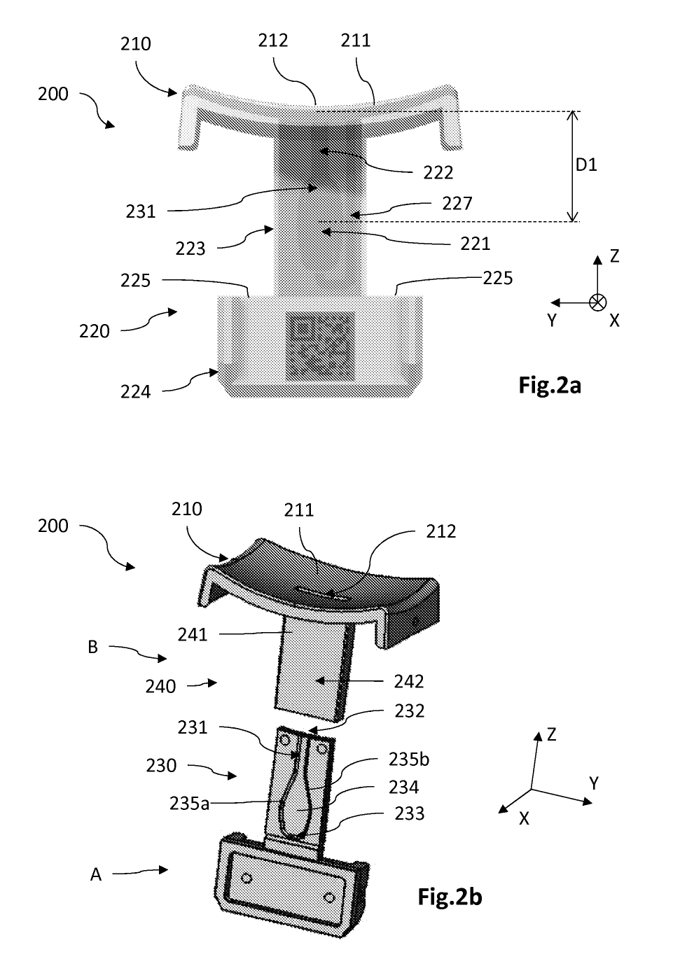

As shown in the figure, an optical reading device 160 reads information present on the main body 220 of the collection device 200 that is engaged in the recess 120. As shown in FIG. 2a, this information can be contained in a QR (Quick Response) code or a Datamatrix code. In some embodiments, the information concerns one or more of: the type of liquid sample to be analyzed, the type of detection to be effected, the types of reagents present in the measurement chamber 221, the expiration date of the collection device 200, and the manufacturing batch number, and other kinds of information.

The optical reading device 160 comprises at least one light source 161 and an optical sensor 162, such as a matrix photodetector. The embodiment shown relies on reflection. As such, the optical sensor 162 is on the same side of the recess 120 as the light source 161. However, other embodiments operate in transmission mode, in which case the optical sensor 162 would be opposite the light source 161.

FIGS. 1a and 1b show that the liquid-sample analyzer 100 and the collection device 200 are both adapted to enable insertion of a part of the collection device 200 into the recess 120 along an insertion axis, or longitudinal axis, that is substantially orthogonal to the receiving surface 211.

In the example shown, the receiving surface 211 is substantially orthogonal to the longitudinal axis of the main body 220 and to the longitudinal axis of the recess 120. It is therefore substantially coplanar with the edge of the opening in the recess 120. This means that it can be made as close as possible to the housing 110 once the collection device 200 has been inserted into the recess 120. This, in turn, makes it possible to minimize that portion of the collection device 200 that is located outside the liquid-sample analyzer 100, and therefore to reduce how long the duct 222 that connects the collection orifice 212 to the measuring chamber needs to be. As a result, less volume of liquid sample is needed.

Moreover, reducing the size of that portion of the collection device 200 that is located outside the liquid-sample analyzer 100 limits the risk of incorrectly manipulating the collection device 200 during the detection step. This reduces the possibility that incorrect manipulation will disturb the detection process and thus falsify the analysis results.

It is advantageous for the opening of the recess 120 to be located at the level of the upper wall of the housing 110 and for that recess 120 to extend substantially orthogonally to the latter or in the direction of the lower wall. The upper and lower walls have dimensions length along the X-axis, a width along the Y-axis, and a thickness along the Z-axis. The length and width are both greater than the thickness.

In some embodiments, the liquid sample is deposited on the receiving surface 211 with a bearing force exerted on the latter surface, for example by having a patient's finger press this surface. The patient therefore exerts a bearing force on the receiving surface 211 that will be parallel to the longitudinal axis of the main body 220. This prevents torsion forces to which connection strips can be subjected.

Moreover, when the collection part contacts the wall of the housing 110, the bearing force is parallel to the longitudinal axis of the recess 120. This better distributes the mechanical stresses to which the collection device is subjected and that are transmitted to the housing 110. During the step of depositing the liquid sample on the receiving surface 211, it is preferably to orient the receiving surface 211 approximately horizontally relative to the direction along which gravity acts.

The collection part 210 extends transversely and projects outward from the main body 220. The receiving surface 211 has a surface area greater than that of the main body's cross-section at the level of the measurement chamber 221. In fact, the main body 220 is relatively narrow transversely since this makes it insertable into a recess 120 of small size. The receiving surface 211, on the other hand, is wider so that it can more easily receive the liquid sample. In some embodiments, the surface area of the main body's cross-section at the level of the measurement chamber 221 is on the order of about ten to a few tens of square millimeters, whereas the surface area of the receiving surface 211 is of the order of about a hundred to a few hundred square millimeters. The size of the receiving surface 211 protects the surface of the liquid-sample analyzer 100, and in particular, the opening 121 of the recess 120, in the event of an excess volume of biological sample or inaccurate deposition of the sample.

The recess 120 of the liquid-sample analyzer 100 and the collection device 200 can both be sized so that when the main body 220 of the collection device 200 is inserted into the recess 120, the distance D1 between the collection orifice 212 and the measurement chamber 221 is approximately equal to the distance D2 between the opening of the recess 121 and the measurement chamber 221. In some embodiments, these distances are less than or equal to two centimeters or even less than or equal to one centimeter.

The distance D1 can be measured between the collection orifice 212 and the longitudinal center along the Z-axis of the measurement chamber 221. In a similar manner, the distance D2 can be measured between the opening 121, for example at the exit surface of the wall of the housing 110, and the longitudinal center along the Z-axis of the measurement chamber 221.

The distances D1 and D2 are approximately equal to each other. The difference between them is less than or equal to 25% of the greater distance and preferably less than 10% of the greater distance. In concrete terms, the distances D1 and D2 are equal apart from the thickness of the collection part 210 when the latter is in contact with the edge of the opening 121. For example, for a thickness of the collection part on the order of two millimeters and for a distance D1 equal to one cm the distance D2 is equal to 0.8 centimeters. This greatly reduces the length of the duct 222 needed to connect a collection orifice 212 to the inlet of the measurement chamber 221.

FIG. 2a is a front view of an example of the collection device 200 according to one embodiment described in the patent application FR1551725 filed Feb. 3, 2015.

The collection device 200 includes a collection part 210, a main body 220, and a collection orifice 212. The collection part 210 has an upper receiving surface 211 to receive the liquid sample. The collection orifice 212 enables introduction of the deposited liquid sample into the collection device. This collection orifice 212 is in fluid communication with a measurement chamber 221 disposed in the main body 220 via a duct 222.

The main body 220 has dimensions suitable for those of the recess 120. It includes a central part 223 assembled to the collection part 210 at one end and into which extend the duct 222 and the measurement chamber 221. The latter chamber is widened along the Y-axis facing the duct 222. In the case of optical detection, this increases the area to be illuminated.

The central part 223 of the main body 220 is assembled at its opposite end to a second part that forms a heelpiece 224. A user uses the heelpiece 224 to hold and manipulate the device easily.

The heelpiece 224 has a width along the Y-axis that is greater than that of the central part 223 of the main body 220. This causes the lateral wall along the Y-axis to include at least one, or in the case shown, two shoulders that define bearing portions 225. The bearing portions 225 cooperate with the locking device of the liquid-sample analyzer 100.

As used herein, the term “shoulder” refers to a sudden variation of the cross section of the main body 220 in order to form a bearing surface oriented in the direction of the collection part. Alternatively, the collection device can include a bearing portion not in the form of a shoulder but in the form of a recess 120 formed in the central part 223 or the heelpiece of the main body 220.

The heelpiece 224 includes an area for written information. Such information can be in the form of a QR code or a Datamatrix code. In the example shown, the heelpiece 224 is located under the measurement chamber 221.

In some embodiments the heelpiece 225 includes at least one projecting portion. In the embodiment shown, there are two portions that extend transversely to the YZ plane of the heelpiece. These portions function as a polarizer that prevents errors in the use or manipulation of the collection device. In such embodiments, the recess 120 has a shape enabling it to receive the main body 220 that includes such polarizers.

FIG. 2b shows a perspective view of the collection device example shown in FIG. 2a.

The collection device 200 includes first and second elements A and B separate from each other and intended to cooperate with each other to render the device operational.

The first element A comprises a male part 230 at the level of which is located a channel 231 with an open cross section. The channel 231 extends longitudinally between a first inlet end 232 adapted to receive a liquid sample, and a second end 233. A bottom wall 234 and two lateral walls 235a, 235b that flank the bottom wall 234 together form the channel 231.

The second element B includes a female part 240 formed by a peripheral wall 241 that transversely delimits a cavity that receives the male part 230. A part of the peripheral wall 241 forms a cap 242 that closes the cross section of the channel 231 when the female part 240 houses the male part 230. The female part 240 joins the collection part 210, which extends transversely to the longitudinal axis of the male part 230 and the female part 240.

Accordingly, to render the collection device 200 operational, the male part 230 of the first element A is introduced into the female part 240 of the second element B so that the peripheral wall 241 closes the cross section of the channel 231, preferably over the entire length of the channel 231. A liquid sample can then be brought into contact with the inlet end 232 of the channel 231 via the collection orifice 212 in the receiving surface 211. The liquid then enters the channel 231 and, through capillary action, flows along the channel 231 in the direction of the second end 233.

Having a collection device 200 with separate first and second elements A and B and a channel 231 that has an open cross section at the longitudinal level has certain advantages. First, before insertion of the male part 230 in the female part 240, there is direct access to the interior of the channel 231. Second, after insertion of the male part 230 into the female part 240, the channel's ability to confine improves.

Direct access to the interior of the channel 231, i.e. to its internal volume and to at least a part of its internal surfaces, makes it easy to functionalize or treat the channel's interior. For example, if one wishes to deposit, within the channel 231, a dried or freeze-dried reagent intended to interact with the liquid sample, it is easy to do so with direct access to the channel's interior. The fact that one can access the interior along its entire length makes it easier to deposit a homogeneous layer of reagent all along the channel 231. The tools needed to deposit the reagent or reagents to be dried or freeze-dried can then be simplified and will not require such precision. It is equally possible simply to produce a localized deposit of the reagent or reagents to be dried or freeze-dried directly in a required area of the channel 231, whether the required area is the inlet, the middle, or the outlet of the channel 231. It is equally possible to deposit simply and accurately in the channel electrodes or an absorbent membrane, or even to functionalize by chemical bonding to the interior of the channel 231, for example by local immobilization of one or more chemical molecules or biological entities (protein, DNA sequence, antibody, etc.), directly onto a wall of the channel 231, for example using a covalent chemical bond.

When the female part 240 receives the male part 230, the collection device 200 more effectively confines the channel 231. This makes it possible to limit or even to avoid contamination of the external environment by the liquid present in the channel 231 and pollution of the channel 231 from the outside.

In the illustrated example, a plate having a substantially rectangular cross-section forms the male part 230. The channel 231 is disposed at the level of a longitudinal upper face of the plate. As a result, the inlet end 232 of the channel 231 leads to a transverse end wall of the plate. Although the illustrated plate has a rectangular cross section, plates with other cross section can be used. For example, the cross-section can be square, which of course is the limiting case of a rectangle. Or it can be circular.

In a preferred embodiment, the longitudinal bottom wall 234 of the channel 231 has a cross-sectional dimension that is greater than that of each of the flanks 235a, 235b. As a result, the transverse form factor of the channel 231, namely the ratio between the width of the channel 231 and its depth, is greater than one. In even more preferred embodiments, this ratio is greater than 5 or even greater than 10.

In the illustrated example, the peripheral wall 241 of the female part 240 extends longitudinally along the Z-axis forms a cavity that receives the male part 230, preferably in its entirety. Moreover, the peripheral wall 241 contacts the perimeter of the male part 230 when the female part 240 receives the male part 230.

The peripheral wall 241 forms a cavity having a substantially rectangular cross-section in the XY-plane. This cavity corresponds to the rectangular cross-section of the male part 230. However, any other shape complementary to that of the male part 230 is suitable. The cavity extends between an insertion opening, through which the male part 230 is introduced, and the collection orifice 212.

The second element B further includes the receiving surface 211. In the illustrated embodiment, the receiving surface 211 takes the form of a cup that receives the liquid sample. The female part 240 is assembled with the receiving surface 211 so that the collection orifice 212 of the cavity leads to the receiving surface 211.

The receiving surface 211 projects from the main body 220 and substantially orthogonally to the female part 240. In some embodiments, the receiving surface 211 is concave. This facilitates bringing the liquid sample into contact with the collection orifice 212. This curved shape is also particularly suitable for depositing a droplet hanging from the end of a finger of a patient, such as when collecting capillary blood from the end of a finger.

Accordingly, when a liquid sample is deposited on the receiving surface 211 and comes into contact with the collection orifice 212, it is introduced by capillary action in the channel 231 at its inlet end 232 in a first part that forms the fluidic duct 222 as far as the measurement chamber 221.

To encourage the introduction of the liquid sample into the channel 231 by capillary action, the walls of the collection device 200 ideally have a wetting angle less than 90° and ideally less than 50°. This can be achieved by choosing materials inherently having this wetting angle or by chemical treatment after the first and second elements A and B of the device have been manufactured. Oxygen plasma treatment or treatment by exposure to an intense UV lamp in the presence of oxygen or ozone can also be used.

Referring to FIG. 2a, at the level of the end of the measurement chamber 221 opposite the fluid duct 222, an air vent 227 communicates with the measurement chamber 221 via a duct 222 the width of which can be less than that of the measurement chamber 221. This duct 222 stops flow of liquid because of the difference between its width and that of the measurement chamber 221. As such, the duct 222 functions as a passive valve

The collection device 200 can generally be used as a disposable single-use device allowing analysis of the sample by appropriate means, possibly carried out away from an analysis laboratory.

The liquid-sample analyzer 100 can be based on an optical signal emitted by the liquid sample or modified by the liquid sample, the walls of the main body 220 allowing the transmission of the optical signal to be measured, and where applicable the transmission of illuminating beams emitted by a light source in the direction of the liquid sample.

The liquid-sample analyzer 100 can also be based on electrical analysis of the liquid sample. In this embodiment, one or more electrodes are disposed measurement chamber 221 and electrically connect to a source of voltage or current when the collection device 200 is inserted into the liquid-sample analyzer 100. An embodiment of the electrodes can be manufactured by thin layer deposition of the electrodes and contact tracks enabling contact to be extended to the heelpiece 224 of the main body 220.

The collection device 200, and in particular the male part 230 and the female part 240 thereof, can be produced by molding or injection molding plastic. Suitable plastics include polycarbonate, polypropylene, polyethylene, cyclo-olefin-copolymer (COC), and cyclo-olefin-polymer (COP). Other similar materials are suitable.

In those embodiments in which analysis is carried out using light, it is preferable that the material forming the male and female parts 230, 240 be transparent to the relevant wavelength of light. Such light includes light with wavelengths in the visible range and in the infrared range.

The total length of the collection device 200 along the Z-axis is on the order of a few centimeters, for example two centimeters.

The cup has an area of a few square centimeters, for example 2 cm×1 cm.

The collection orifice 212 can have a length of a few millimeters, for example 5 millimeters, over a width of 0.1 mm to 1 mm.

The male part 230 can have a length and a width of a few millimeters, for example 10 mm×5 mm, for a thickness of a few hundred microns or even a few millimeters, for example 1 mm.

The channel 231 can have a length of a few millimeters or centimeters, a width of a few hundred microns to a few millimeters, and a thickness of the order of a few tens of microns to a few millimeters.

In some embodiments, the measurement chamber 221 extends along the Z-axis by 6.5 millimeters, extends along the Y-axis at its widest area by 3 millimeters in its widest area, and extends along the X-axis by 150 micrometers.

The dimensions of the above components are given by way of illustration only.

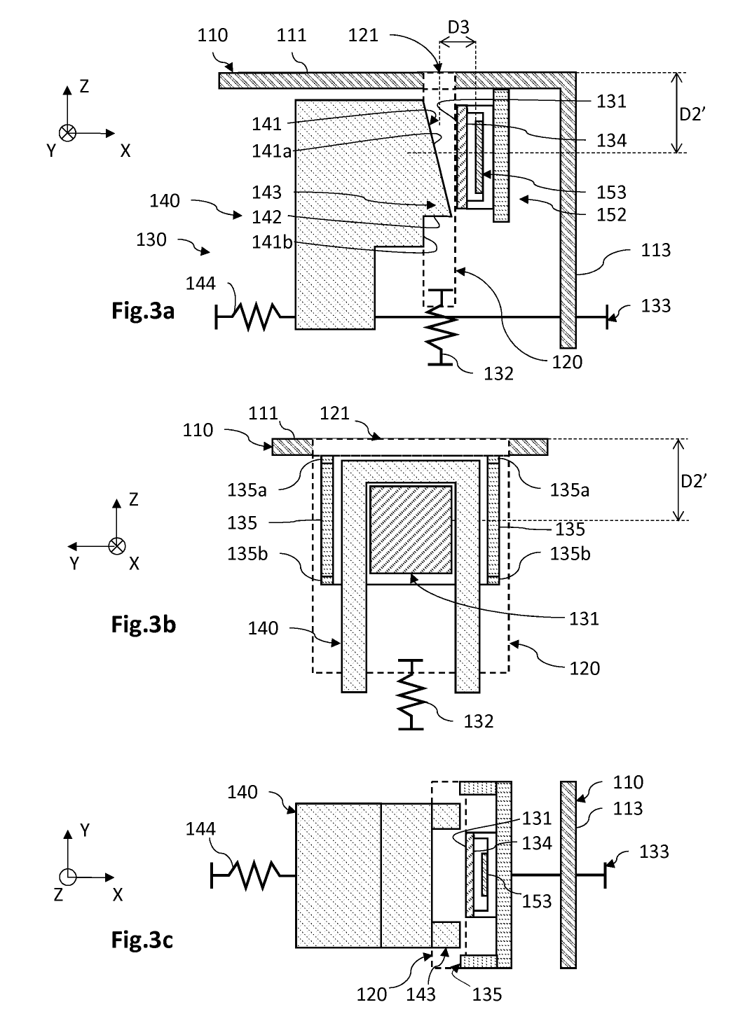

FIGS. 3a to 3c are views of a part of the liquid-sample analyzer 100 that is adapted to receive a collection device 200 and that includes a device for locking and releasing the collection device 200. The collection device 200 can be that described with reference to FIGS. 2a and 2b. However, the same principles are applicable to a collection device 200 with the collection part parallel to and coplanar with the main body 220.

In FIG. 3a, a dashed outline shows the recess 120 extending into the housing's interior space from the opening 121, which is level with the housing's upper part 111. The locking-and-releasing device 130 delimits part of the recess 120.

The locking-and-releasing device 130 is adapted to retain the collection device 200 in a locking position when the main body 220 is inserted into the recess 120. The locking-and-releasing device 130 includes a releasing member 132, a locking member 140, an unlocking member 133 and the bearing surface 131.

The releasing member 132 exerts an ejection force on the main body 220 of the collection device 200 in a direction substantially parallel to the longitudinal axis of the recess 120 and oriented toward the opening 121 of the recess 120.

The locking member 140 includes an abutment portion 143 adapted to be in contact with a bearing portion 225 of the main body 220. This abutment portion 143 participates in immobilizing the collection device 200, which is being subjected to the ejection force along the longitudinal axis of the recess 120.

The locking member 140 moves away from or toward the recess 120 relative to the housing 110. It includes a contact surface 141.

The locking member's contact surface 141 has an engagement portion 141a, an abutment portion 143, and a bearing portion 141b. The entire contact surface 141 is oriented to face the recess 120.

The engagement portion 141a is located closest to and in the vicinity of the opening 121. It forms an inclined surface that is inclined relative to the recess' longitudinal axis. The inclination is such that the locking member 140 extends progressively toward the recess' longitudinal axis as one proceeds away from the recess' opening 121.

Unlike the engagement portion 141a, the bearing portion 141b is not inclined. Instead, the bearing portion 141b is parallel to the recess' longitudinal axis.

A step marks the boundary between the engagement portion 141a and the bearing portion 141b. This step form an abutment surface 142 of the abutment portion 143. The abutment surface 142 faces the distal part of the recess 120 relative to its opening.

The locking member 140 translates along the X-axis and can thus move away from or toward the recess 120. However, a return element 144 exerts a force that urges the locking member 140 toward the recess 120 the direction+X direction. In the illustrated embodiment, the return element 144 is a compression spring.

The unlocking member 133 moves the locking member 140 in away from the recess 120, namely in the −X direction. As such, the unlocking member 133 pushes the abutment portion 143 out of the recess 120. In the illustrated embodiment, the unlocking member 133 is a pushbutton disposed outside the housing 110 and rigidly connected to the locking member 140.

The releasing member 132 faces the lower part of the recess 120. It exerts an ejection force on the collection device 200 when the collection device 200 has been inserted into the recess 120. In the illustrated embodiment, this ejection force is along the longitudinal axis of the recess 120, i.e., in the +Z direction.

The bearing surface 131 extends along a part of the recess 120 in parallel to the recess' longitudinal axis. Unlike the other parts of the locking-and-releasing device 130, the bearing surface 131 is fixed to the housing 110. It does not move. In the illustrated embodiment, a surface of a plate fixed along the recess 120 forms the bearing surface 131.

In those embodiments that analyze the liquid using optical methods, the plate that forms the bearing surface 131 is transparent. The bearing surface 131 separates an optical sensor 152 from the recess 120. However, since the bearing surface 131 is transparent, light can pass through it and reach the optical sensor 152 when the collection device 200 is inserted into the recess 120.

In those embodiments that rely on optical detection, the detection-and-analysis device 150 includes an optical sensor 152 located at a longitudinal distance D2′ relative to the opening 121 of the lower housing 120 or equal to two centimeters, and preferably less than or equal to one centimeter, and/or is located at a transverse distance D3 relative to the lower housing 120 or equal to two centimeters, and preferably less than or equal to one centimeter. By the longitudinal distance D2′, is meant the distance measured between the opening 121, for example at the surface of the wall of the housing opening to the external environment, and the longitudinal center along the Z-axis of the photodetector 153 of the optical sensor 152; and by the transverse distance D3, is meant the distance measured between the transverse center of the recess 120 along the X-axis and the detection surface of the photodetector 153.

In FIG. 3b, which is a view of the elements shown in FIG. 3a along the X-axis, the locking member 140 has an inverted U-shape that defines a hollow part. This hollow part permits a light source situated on the opposite side of the locking member 140 to the recess 120 to project illumination beams in the direction of the optical sensor 152 without the beams being optically disturbed by the locking member 140.

The locking-and-releasing device 130 advantageously includes, in the case of optical detection, at least one (here two) spacing elements 135 disposed on respective opposite sides of the transparent bearing surface 131. These spacing elements 135 enable the collection device 200 to be moved away from the bearing surface 131 during phases of insertion and ejection or releasing. Here is each formed by a strip 135 parallel to the longitudinal axis of the recess 120 that extends the whole of the dimension along Z of the bearing surface 131, and advantageously as far as the abutment surface 142 of the locking member 140. Moreover, this strip is beveled at its longitudinal ends 135a, 135b to prevent any jamming of the collection device 200 during phases of insertion and ejection or releasing. To move the latter device away from the bearing surface 131 during its insertion and its ejection or releasing, these strips project relative to the bearing surface, for example by a few hundred microns to a few millimeters, for example of the order of 200 micrometers. This makes it possible to avoid the risks of the collection device 200 rubbing on the transparent bearing surface 131, which rubbing is liable to induce deterioration of the optical surface quality of the transparent surface 131, which could disturb the beams transmitted in the direction of the optical sensor, or even also cause deterioration of the assembly of the optical sensor 152 and the plate 134 which would be subjected to a shear stress resulting from this rubbing.

In some embodiments, the optical-detection device includes a photodetector 153 disposed facing the recess 120 through the opposite side of the transparent bearing surface 131, with the bearing surface 131 encapsulating the photodetector 153. The photodetector 153 detects light coming from the liquid sample within the collection device's measurement chamber 221 when the collection device 200 has been inserted into the recess 120. In some embodiments, the light that reaches the photodetector 153 is emitted as a result of a reaction to illumination by a light source 151. Alternatively, light that reaches the photodetector 151 is that light that is transmitted by the liquid sample.

In some embodiments, the photodetector 153 is one that detects infrared light. In others, it detects visible light, and in yet others, it detects ultraviolet light.

In some embodiments, the photodetector 153 is charge-coupled device. In other embodiments, the photodetector 153 is a complementary metal-oxide semiconductor. In yet other embodiments, the photodetector 153 is a matrix sensor configured to acquire an image of the liquid sample.

In some embodiments, the light source 151 shown in FIG. 1b includes one or more light-emitting diodes. In other embodiments, it includes one or more semiconductor laser diodes. Among these are embodiments that include vertical-cavity surface-emitting lasers.

The optical detection device can be adapted to perform optical detection by lensless imaging. This is notably the case when the analytes to be detected in the liquid sample are diffracting objects.

In such embodiments, the light source 151 emits coherent illuminating beams. Suitable light sources 151 for such applications include a laser diode, a semiconductor laser diode, a light-emitting diode including a diaphragm that enhances the coherence of the emitted radiation, and a light-emitting diode having dimensions that are sufficiently small to avoid having to use a diaphragm to enhance the coherence of emitted radiation. A suitable diode with this property is one having a diameter that is less than one tenth of the distance separating the diode from the recess 120.

The photodetector 153 is a matrix device that acquires images of the radiation transmitted and/or diffracted by the analytes present in the liquid sample. It is placed at a distance from the recess 120, for example at a central position in the recess 120 along the X-axis, between 100 micrometers and a few centimeters inclusive, for example less than or equal to 1 centimeter, and advantageously between 100 micrometers and 2 millimeters inclusive. The small distance between the measurement chamber 221 and the photodetector 153 limits interference phenomena. Such interference phenomena include diffraction patterns that arise when illuminating the measurement chamber 221.

Some embodiments avoid the use of any magnification optic between the recess 120 and the photodetector can be avoided. In some of these embodiments, an array of micro-lenses each placed in front of one pixel of the photodetector enhances the optical collection of each pixel of the photodetector without magnification.

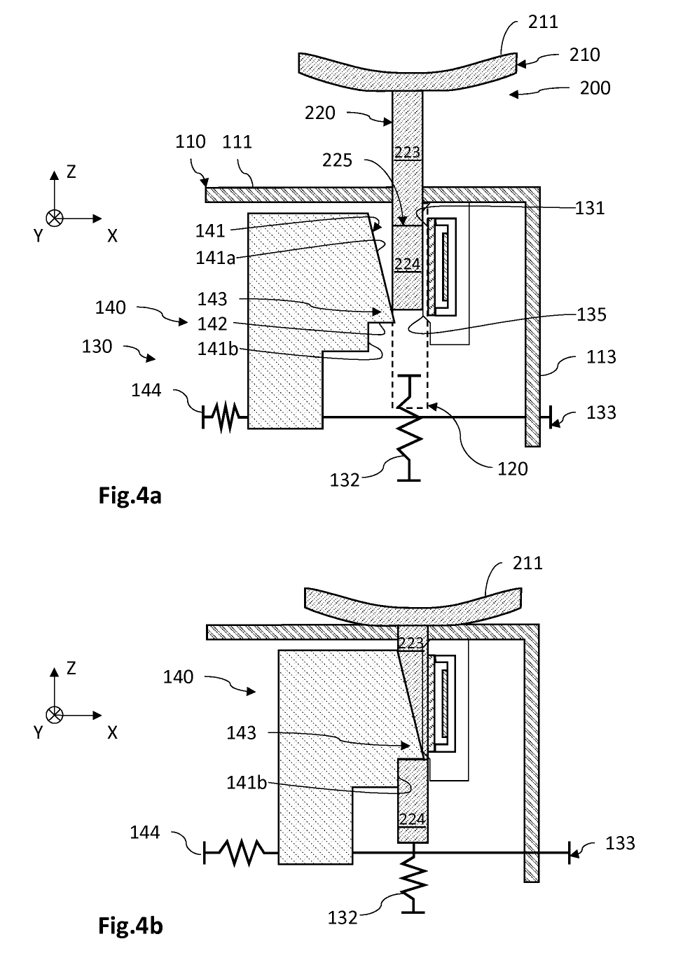

The analysis method is described next with reference to FIGS. 4a and 4b. FIG. 4a shows the collection device 200 being inserted into the liquid-sample analyzer 100. FIG. 4b shows the collection device 200 locked into place.

In FIG. 4a, the collection device 200 is inserted into the recess 120 of the liquid-sample analyzer 100. During this insertion phase, the heelpiece 224 comes into contact with the engagement part 141a of the contact surface 141 of the locking member 140. As it is introduced into the recess 120, the heelpiece 224 progressively pushes the locking member 140 in the −X direction. This loads the return element 144.

Eventually, the heelpiece 224 contacts the releasing member 132 and thus loads the releasing member 132. In the illustrated embodiment, the releasing member 132 is a spring that, when compress, exerts a force that urges the collection device 200 outward.

Optional spacing elements 135 prevent the collection device 200 from rubbing on the bearing surface 131 during movement thereof. In the illustrated embodiment, the spacing elements 135 take the form of strips.

Contact between the spacing elements 135 and the heelpiece 224 moves the main body 220 away from the bearing surface 131 before the abutment portion 143 of the locking member engages the bearing portion 225 of the main body 220.

In FIG. 4b, the locking position has been reached. This occurs when the bearing portions 225 of the main body 220, which are shown in FIG. 4a, pass beyond the abutment portion 143 of the locking member 140 in the −Z direction. When this occurs, the return element 144 pushes the locking member 140 toward the recess 120. This brings the abutment portion 143 into contact with the bearing portion 225.

At the same time, the bearing part 141b of the contact surface 141 exerts a force on the heelpiece 224 of the collection device 200 in the +X direction. By this time, the heelpiece 224 no longer contacts the spacing elements 135 and the central part 223 of the main body 220, the width of which along the Y-axis is less than that of the heelpiece 224 and the distance between the spacing elements 135. As a result, the collection device 200 contacts the bearing surface 131.

The collection device 200 is therefore immobilized on the Z-axis by the conjoined action of the releasing member 132, which exerts on it a force in the +Z direction, and the abutment portion 143 of the locking member 140, which exerts a reaction force in the −Z direction on the bearing portion 225 of the collection device 200. Moreover, the collection device 200 is immobilized on the X-axis by the contact with the bearing surface 131 by virtue of the force exerted in the +X direction by the bearing part 141b of the contact surface 141 of the locking member 140 against the heelpiece 224.

The collection device 200 is therefore locked in the recess 120 and positioned in a perfectly controlled manner relative to the bearing surface. This suppresses risk of involuntary movement of the collection device 200 during the subsequent detection step thus promoting the accuracy and the reliability of detection based on an optical technique, in particular when the lensless imaging technique described above is used.

Once the collection device 200 is locked in place, as shown in FIG. 4b, a volume of liquid is deposited on the receiving surface 211 of the collection device 200. This might be, for example, a drop of blood from a person's finger. At this stage, the receiving surface 211 can be oriented substantially orthogonally to the direction of the gravity vector.

The mechanical stresses to which the collection device 200 is subjected and that are transmitted into the wall of the housing are minimized if the collection part is in contact with the housing when a user presses on the receiving surface 211. Moreover, this arrangement of the receiving surface 211 relative to the measurement chamber 221 makes it possible to deposit only a limited volume of liquid sample and to minimize the distance separating the collection orifice 212 from the measurement chamber 221 and that separating the opening of the recess 120 from the optical sensor. A user can hold the liquid-sample analyzer 100 during this deposition phase.

The liquid sample migrates, for example by capillary action, from the collection orifice 212 in the direction of the measurement chamber 221, dried or freeze-dried reagents being where applicable present in the measurement chamber 221 and/or in the fluidic duct 222 (see FIG. 1b or 2a). In this case, there follows a chemical reaction one parameter of which is detected and then analyzed. For example the detection can be colorimetric, the optical detection device then measuring by photometry the final color of the sample during the reaction, the intensity of the color being proportional to the analyte concentration present in the sample. As described above, it is possible to effect optical detection particularly optimized by lensless imaging, notably by virtue of the fact of the controlled and close positioning of the optical sensor relative to the measurement chamber 221 by way of the bearing surface against which the main body 220 of the collection device 200 is pressed. The raw data coming from the detection device is transmitted to the analysis unit which proceeds to process the measured information and displays the results on the screen for the user.

After detection and possibly analysis of the liquid sample, the collection device 200 can be ejected or released from the liquid-sample analyzer 100 by the user. To this end, the user actuates the unlocking member 133 which results in movement of the locking member 140 until it causes release of the abutment, i.e. elimination of mechanical contact between the abutment portion 143 and the bearing portion 225 of the collection device 200. The return force applied to the collection device 200 by the releasing member 132, here the loaded spring, results in preferably partial ejection, in other words partial releasing, of the latter device relative to the recess 120. When the spacing elements 135 are present, the heelpiece 224 comes into contact with the spacing elements so that the collection device 200 is no longer in contact with the transparent bearing surface 131 at any time in the movement phase. Here the ejection force therefore results in partial releasing of the collection device 200, which is partly housed in the recess 120 in an unlocked position. It is then possible to turn the liquid-sample analyzer 100 over so that the collection device 200 is ejected completely from the recess 120 by its own weight and where applicable drops into a container provided for this purpose. This makes it possible to avoid having to manipulate the collection device 200 the receiving surface 211 of which may contain traces of liquid sample. Of course, by way of an alternative, the return force of the releasing member 132 can be sufficient to results in total ejection of the collection device 200 out of the recess 120.

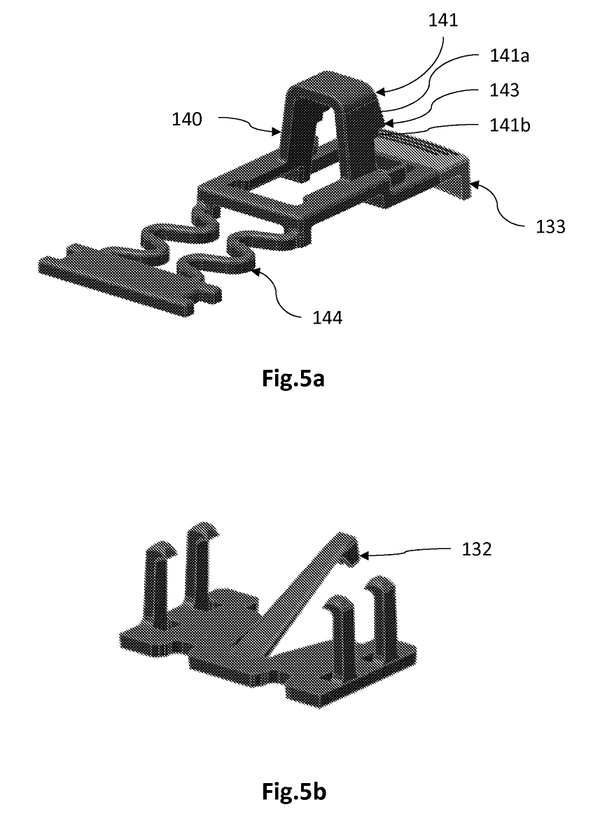

FIGS. 5a and 5b are perspective views of an example of a part of the locking and releasing device 130. In particular, FIG. 5a shows the locking member and FIG. 5b shows the releasing member.

FIG. 5a shows a one-piece mechanical part that has a ridge-shaped hollow docking member 140 that rests on a rigid base. The rigid base has first and second extensions that extend in opposite directions. The first extension is a rigid extension that forms an unlocking member 133. In the illustrated embodiment, the unlocking member 133 is a pushbutton. The second extension is a flexible extension that forms the return element 144. In the illustrated embodiment, the return element 144 takes the form of a compression spring.

FIG. 5b shows a disengagement member 132. The disengagement member 132 has a flexible blade that is inclined so that it can exert an ejection force when the collection device 200 is inserted into the recess 120 and in a locking position. This part engages under the locking member 140 at the level of the aperture in the base shown in FIG. 5a.

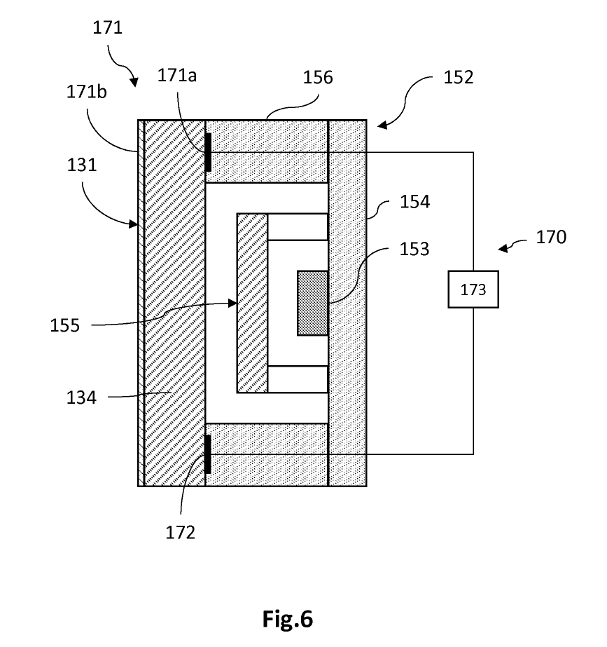

FIG. 6 shows an optical sensor 152 that has a heating device 170 to enable thermal regulation of the bearing surface 131 and thus of the central part 223 of the main body 220 of the collection device 200 containing the measurement chamber 221.

The embodiment of FIG. 6 has first and second electronic circuit cards 154, 156. Examples of such circuit cards are printed circuit boards.

The first circuit card 154 includes a photodetector 153 that forms part of the optical sensor 152. The photodetector rests on the first circuit card 154 via a ceramic casing. A secondary protection cap 155 encapsulates the photodetector 153. The protection cap 155 has a plate that is transparent to incident light. Suitable circuitry on the first circuit card 154 supplies power to the photodetector 153 and transmits signals from the photodetector 153 to the analysis unit.

The second circuit card 156 the plate 134 of the bearing surface 131, which faces the recess 120.

The second circuit card 156 also includes a portion of a heating device 170. The heating device 170 includes a at least one heating element 171, preferably at least one temperature probe 172, and a thermal regulation unit 173. The thermal regulation unit 173 electrically connects to both the heating element 171 and the temperature probe 172.

The heating element 171 emits heat, for example by the Joule effect. When the main body 200 contacts the bearing surface 131, the heating element 171 transmits heat to the central part 223 of the main body 200.

The heating element 171 is positioned so as to be able to transmit this heat when the central part 223 of the main body 220 contacts the bearing surface 131. In some embodiments, the heating element 171 includes an electrically conductive structure, such as a metal track 171a, that gives off heat when it carries an electrical current associated with a thermally conductive layer 171b, which is preferably a transparent layer.

In the illustrated embodiment, the thermally conductive layer 171b is level with the surface of the plate 134 oriented toward the recess and thus forms the bearing surface 131. Alternatively, the thermally conductive layer 171b is disposed on its opposite face.

In some embodiments, the thermally conductive layer 171b is a layer of a transparent material, such as amorphous silicon or indium-tin oxide screen-printed or sprayed onto the face of the plate 134. The thermally conductive layer 172b propagates heat emitted by the metal track 171a, the latter being for example situated at the interface between the second circuit card 156 and the bearing plate 134. It is electrically connected to a current source, for example via the surrounding stud and the electronic circuit card, the latter then being connected to the thermal regulation unit 173.

As an alternative, the heating element can include the bearing plate 134 in addition to the electrically conductive track 171a. In such embodiments, the bearing plate 134 is made from a thermally conductive and preferably optically transparent material, such as sapphire. The thermally conductive layer 171b can then be omitted.

The temperature probe 172 is positioned as close as possible to the bearing surface 131.

The thermal regulation unit 173 is electrically connected to the metal track 171a and to the temperature probe 172. In response to a signal indicative of temperature as provided by the temperature probe 172, the thermal regulation unit 173 sends a signal to a current source to draw more current, if the temperature is below a target temperature, or to draw less or no current of the temperature is above the target temperature. This controls how much current flows in the metal track 171a and hence the amount of heat generated. This target temperature value can be corrected as a function of the value of the temperature measured by the probe 172.

The heating device 170 thus enables thermal regulation of the liquid sample while the main body 220 of the collection device 200 contacts with the bearing surface 131. In this embodiment, the bearing surface serves the dual function of both controlled position and temperature of the measurement chamber 221.

Accordingly the detection device can effect electrochemical detection of one or more properties of the liquid sample, instead of or in addition to optical detection. To this end, the measurement chamber 221 can include one or more electrodes. When the collection device 200 is inserted into the liquid-sample analyzer 100, these electrodes can come into contact with electrical contact areas, for example positioned at the level of the bearing surface, these areas being electrically connected to a source of voltage or current. Accordingly, a potential or current difference can be applied to the electrodes and an electrochemical property of the liquid can be detected and then analyzed.

Moreover, there has been described a recess the opening of which is located at the level of the upper wall of the housing. It can be located at the level of the lateral wall, however, notably if the liquid-sample analyzer 100 is intended to cooperate with a collection device 200 the collection part of which is parallel to and substantially coplanar with the main body 220 containing the measurement chamber 221. Particular embodiments have just been described. Various variants and modifications will be apparent to the person skilled in the art.

1-17. (canceled)

18. An apparatus for analyzing a liquid sample, said apparatus comprising a liquid-sample analyzer, wherein said liquid-sample analyzer comprises a housing, a detection-and-analysis device, and a locking-and-releasing device, wherein said locking-and-releasing device comprises a releasing member and a locking member, wherein said locking member comprises an abutment portion, wherein said housing comprises an opening that leads into a recess, wherein said recess extends along an insertion axis, wherein said housing delimits an interior space, wherein said recess is adapted to receive a main body of a collection device that collects said liquid sample, wherein, when inserted into said recess, said main body extends longitudinally from said opening along a longitudinal axis of said collection device, wherein said detection-and-analysis device is configured to detect and to analyze at least one representative parameter of said liquid sample, wherein said locking-and-releasing device is adapted to retain said collection device in a locking position when said main body has been inserted into said recess, wherein said releasing member is adapted to exert an ejection force on said main body in a direction substantially parallel to said insertion axis and directed toward said opening, and wherein said abutment portion is adapted to contact a bearing portion of said main body so as to immobilize said collection device while said main body is subjected to said ejection force.

19. The apparatus of claim 18, wherein said liquid-sample analyzer comprises a bearing surface, wherein said bearing surface is fixed relative to said recess, wherein said bearing surface is disposed to delimit at least a portion of said recess, wherein said bearing surface extends parallel to said insertion axis, and wherein, when said main body is inserted into said recess, said bearing surface contacts a portion of said main body that contains a fluid-measurement chamber.

20. The apparatus of claim 18, wherein said locking member is mobile relative to said recess along a direction that is substantially transverse to said insertion axis, and wherein said locking member is adapted to exert a bearing force on said main body in a direction of said bearing surface when said main body is inserted into said recess.

21. The apparatus of claim 18, wherein said locking member comprises a contact surface, wherein said contact surface comprises a spacing part and a distal bearing part, wherein said contact surface is oriented toward said recess, wherein said spacing part is proximal to an opening of said recess, wherein said spacing part is inclined relative to said insertion axis, and wherein said abutment portion is between said bearing part and said spacing part.

22. The apparatus of claim 18, wherein said locking-and-releasing device comprises an unlocking member, wherein actuation of said unlocking member causes said locking member to be moved so as to cause said locking member to escape from abutment between said abutment portion and said bearing portion, wherein, as a result of said escape, said ejection force causes said main body to move outward from said recess.

23. The apparatus of claim 19, further comprising a spacing element disposed longitudinally along an edge of said bearing surface, wherein said spacing element comprises beveled longitudinal ends so as to move said main body from said bearing surface when said main body moves within said recess along said insertion axis.

24. The apparatus of claim 19, wherein said detection-and-analysis device comprises an optical sensor, wherein said bearing surface lies between said optical sensor and said recess, and wherein said bearing surface is transparent to light that emanates from said fluid-measurement chamber when said collection device has been inserted into said recess.

25. The apparatus of claim 18, wherein said detection-and-analysis device comprises an optical sensor, wherein said optical sensor is separated from said opening along said insertion axis by a first distance, wherein said insertion axis defines a radial direction, wherein said optical sensor is separated from said insertion axis along said radial direction by a second distance, wherein at least one of first distance is less than or equal to two centimeters and said second distance is less than or equal to two centimeters.

26. The apparatus of claim 19, further comprising a heating device, wherein said heating device comprises a heating element, wherein said heating element is adapted to transmit heat to said main body via said bearing surface when, after having been inserted into said recess, said main body contacts said bearing surface.

27. The apparatus of claim 18, wherein said detection-and-analysis device comprises a light source and an optical sensor, wherein said locking member comprises a hollow part, wherein said light source and said optical sensor are on opposite sides of said recess along an illumination axis, wherein said hollow part is between said light source and said optical sensor such that light from said light source travels along said illumination axis through said hollow part towards said optical sensor.

28. The apparatus of claim 18, wherein said housing comprises an upper wall, a lower wall, and a lateral wall, wherein said lateral wall connects said upper wall to said lower wall, wherein said lateral wall has extends between said upper and lower walls by a distance that is less than a shortest lineal dimension of said upper and lower walls wherein said opening is level with said upper wall, wherein said recess extends substantially orthogonally from said upper wall towards said lower wall.

29. The apparatus of claim 18, further comprising a display screen, wherein said display screen is disposed on an upper wall of said housing from which said recess extends orthogonally toward a lower wall of said housing, said upper and lower wall being connected to each other by a lateral wall of said housing.

30. The apparatus of claim 18, further comprising said collection device, wherein said collection device further comprises a receiving surface, a collection orifice, and a fluid-measurement chamber, wherein said fluid-measurement chamber is disposed in said main body, wherein said main body is adapted to be inserted into said housing along said insertion axis, wherein said receiving surface is adapted to be located outside said recess when said main body is inserted into said recess, wherein said receiving surface is assembled with said main body, wherein said receiving surface comprises said collection orifice, wherein said receiving surface receives said liquid sample and guides it to said collection orifice, wherein said collection orifice is in fluid communication with said fluid-measurement chamber, and wherein said liquid sample passes through said collection orifice and into said fluid-measurement chamber.

31. The apparatus of claim 30, wherein said receiving surface extends in an orthogonal manner relative to said longitudinal axis of said main body.

32. The apparatus of claim 31, wherein said recess and said collection device are sized such that, when said main body is inserted into said recess, there exists a first distance and a second distance, wherein said first distance is a distance between said collection orifice and said fluid-measurement chamber, wherein said second distance is a distance between said opening of said recess and said fluid-measurement chamber, wherein said first and second distances are approximately equal.

33. The apparatus of claim 32, wherein said first distance is less than or equal to two centimeters.

34. The apparatus of claim 31, wherein said collection device further comprises a collection part, wherein said collection part is assembled to said main body, wherein a surface of said collection part forms said receiving surface, wherein said collection part contacts a wall of said housing at an edge of said opening when said main body is inserted into said recess.

35. The apparatus of claim 30, wherein said main body comprises a shoulder, a central part, and a distal end, wherein said fluid-measurement chamber is disposed in said central part, wherein said shoulder forms said bearing portion, wherein said shoulder is disposed between said central part and said distal end, and wherein said shoulder faces said fluid-measurement chamber.
